(19) United States
(12) Patent Application Publication
(10) Pub. No.: US 2026/0026996 A1
(43) Pub. Date: Jan. 29, 2026

(54) Multifunctional Axillary Crutch Device Capable of Standing and Functioning as a Wheelchair and Mobile Bed

(71) Applicant: Zhenkun Zack Wang, Cambridge, MA (US)

(72) Inventor: Zhenkun Zack Wang, Cambridge, MA (US)

(21) Appl. No.: 19/278,491

(22) Filed: Jul. 23, 2025

(30) Foreign Application Priority Data
Jan. 30, 2024 (CN) 2024220164592

(51) Int. Cl. A61H 3/02; A61G 5/00; A61G 5/02; A61G 5/08

(52) U.S. Cl. CPC A61H 3/02; A61G 5/006; A61G 5/02; A61G 5/0875; A61H 2003/0272

(57) ABSTRACT

A multifunctional axillary crutch device functions as a crutch, wheelchair, and mobile bed. It resembles a conventional axillary crutch and retains all its functions. Four expandable support legs allow the device to stand when released and locked. When two crutches are standing opposite each other, the upper part of one folds horizontally and buckles onto the other to form a seat. Pulleys on the support legs enable wheelchair use. Above the folding point, all components are telescopic and extendable for use as a mobile bed. A magnetic adsorption system allows automatic leg deployment during emergencies to prevent falls. For frail users, the device can switch to strong support mode, enhancing grip and stability to avoid accidents.

### UTILITY MODEL CONTENT

1. The objective of the present utility model is to provide a multifunctional axillary crutch device capable of standing, integrating the four functions of an axillary crutch, seat, wheelchair, and mobile bed, to meet the diverse functional needs of specific populations. It is characterized in that: its appearance resembles a conventional axillary crutch and possesses all functionalities of a conventional axillary crutch. It is equipped with four expandable support legs; releasing and locking the expandable support legs enables the crutch to assume a standing state; when two crutches are in a standing state opposite each other, the upper part of one crutch can be folded down to a horizontal position; the folded part is buckled onto the other crutch to form a seat; pulleys are installed below the four expandable support legs, enabling its wheelchair functionality; the structural components above the folding position of this device are all telescopic and can be extended in length and width for use as a mobile bed. Additionally, benefiting from its unique magnetic adsorption design, the support legs can automatically deploy in emergency situations, enabling the device to stand and prevent the user from falling. For frail individuals prone to falling, this device can be adjusted to a strong support mode as needed, enhancing the crutch's grip and support for the human body, avoiding user falls. In this mode, the support legs are released and always remain perpendicular to the ground within a certain angle range. During the user's walking process, when the crutch touches the ground, it is supported by four support legs, maintaining good grip and providing the user with strong support and assistance to prevent falls. This angle range can be adjusted according to the user's stride length, and the specific relationship is as follows:

| Height of support legs (cm) | | | 10 | | | | | |
|---|---|---|---|---|---|---|---|---|
| | Crutch | Suitable | Tilt angle (°)-Stride Length (cm) | | | | | |
| | Height | User Height | Tilt angle (°) | | | | | |
| | (cm) | (cm) | 5 | 10 | 15 | 20 | 25 | 30 |
| Calculated | 100 | 141 | 8 | 16 | 23 | 31 | 38 | 45 |
| Stride | 110 | 151 | 9 | 17 | 26 | 34 | 42 | 50 |
| Length | 120 | 161 | 10 | 19 | 28 | 38 | 46 | 55 |
| (cm) | 130 | 171 | 10 | 21 | 31 | 41 | 51 | 60 |
| | 140 | 181 | 11 | 23 | 34 | 44 | 55 | 65 |
| | 150 | 191 | 12 | 24 | 36 | 48 | 59 | 70 |

### BRIEF DESCRIPTION OF THE DRAWINGS

The drawings of the present invention are as follows:

FIG. 1: External View

FIG. 2: Structural Diagram

FIG. 3: Operation Instructions for Lowering Support Legs

FIG. 4: Operation Instructions for Retracting Support Legs

FIG. 5: Crutch Length and Width Extension

FIG. 6: Seat Deployment Schematic

FIG. 7: Three Usage States of the Device

### ILLUSTRATION OF DRAWINGS

1. Canvas
2. Elastic Buckle
3. Internal Device Handle
4. Expandable Support Leg
5. Magnetic Fixing Ring
6. Rope for Pulling Fixing Device 1
7. Direction-Fixed Pulley
8. Spring
9. Fixing Device 1
10. Fixing Device 2
11. Fixing Device 3
12. Pulley

### DETAILED DESCRIPTION OF EMBODIMENTS

The implementation of the present invention will now be described in detail in conjunction with the drawings, providing further detailed explanation of the multifunctional axillary crutch capable of standing and functioning as a wheelchair and mobile bed. Obviously, the described embodiments are only a part of the embodiments of the present invention, not all of them. Based on the embodiments of the present invention, all other embodiments obtained by those of ordinary skill in the art without creative efforts shall fall within the protection scope of the present invention. The multifunctional axillary crutch capable of standing and functioning as a wheelchair and mobile bed described in this embodiment comprises an axillary crutch main body, four expandable support legs, a support leg guiding and fixing device, a magnetic adsorption device, a spring buckle device, etc.

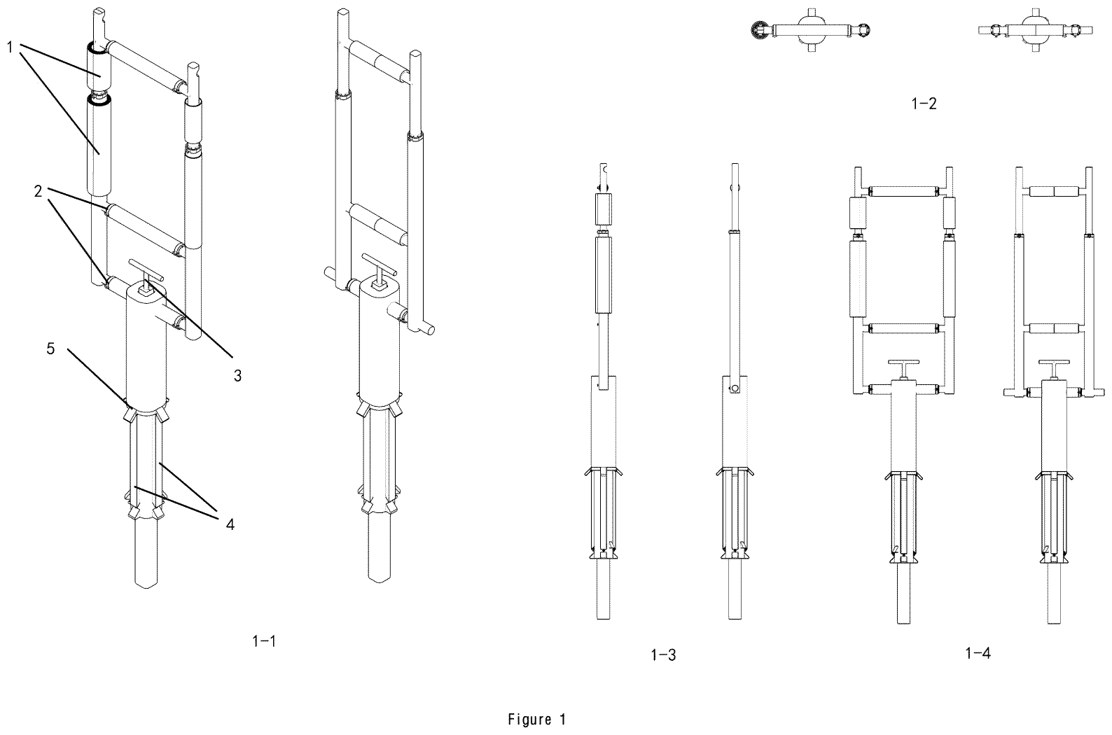

### FIG. 1: External View

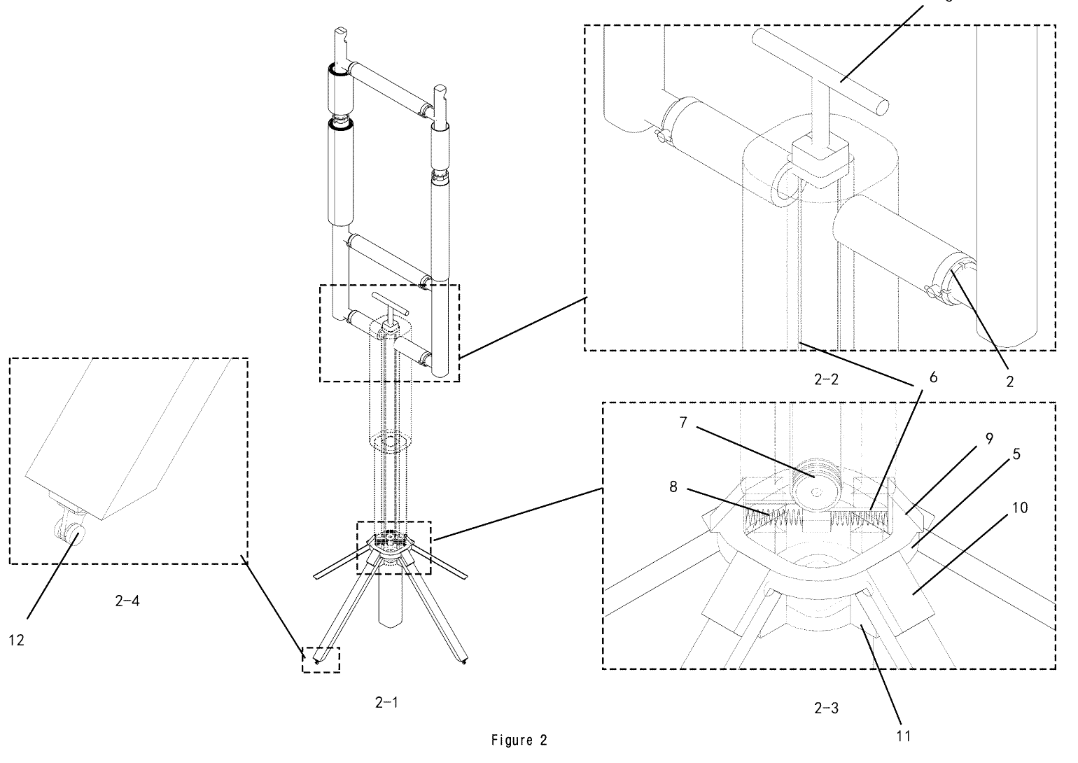

When not deployed, the present invention functions similarly to a conventional axillary crutch. The four expandable support legs 4 are retracted upward and firmly adsorbed onto the axillary crutch main body by the magnetic fixing ring 5; the canvas (1) is folded and stored; the crutch can be adjusted in size via the elastic buckle (2). FIG. 1-1: Axonometric View
FIG. 1-2: Top View
FIG. 1-3: Side View
FIG. 1-4: Front View

### FIG. 2: Structural Diagram

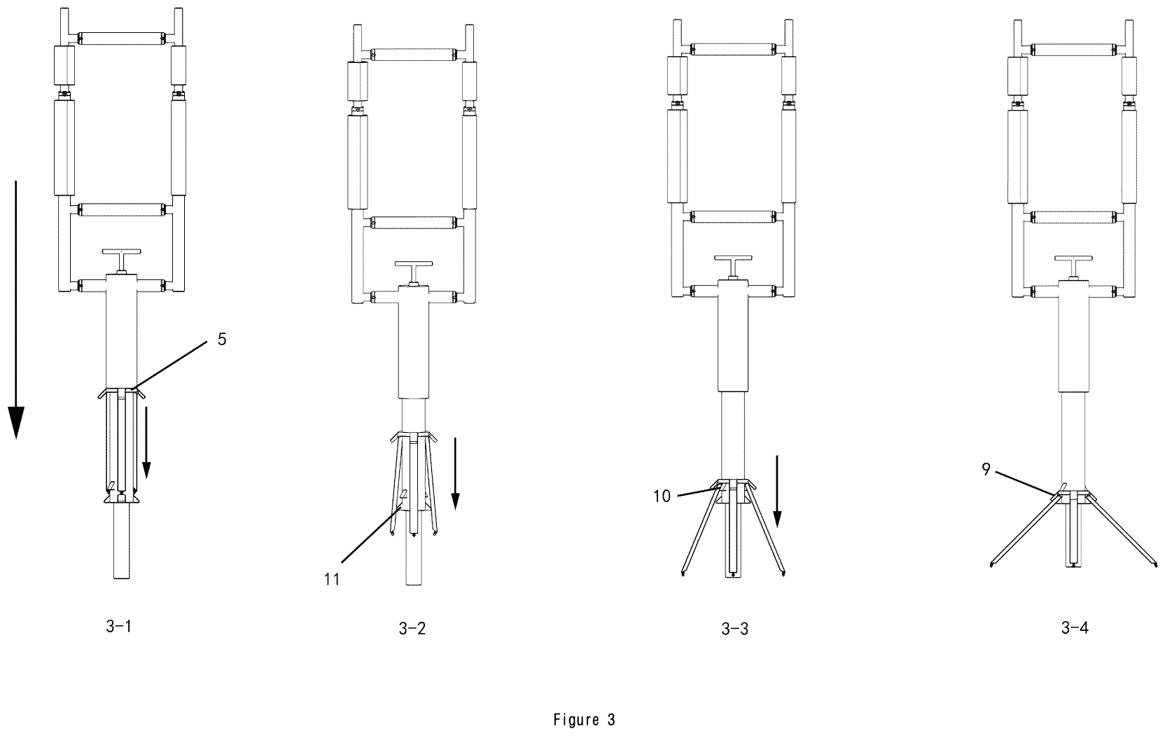

FIG. 2-1: Standing Posture Diagram
FIG. 2-2: Partial Enlarged View of Handle Position
FIG. 2-3: Expandable Support Leg 4 Deployment Diagram. After being released, the expandable support leg 4 undergoes free fall to the lower part of the crutch. Under the action of fixing device 11, the expandable support leg 4 expands outward. Upon reaching a certain angle, it is blocked by fixing device 11 to complete the deployment action. At this time, fixing device 9 extends under the action of spring 8, locking the magnetic fixing ring 5, collectively completing the release and deployment functions of the support leg.
FIG. 2-4: Each support leg 4 is equipped with a pulley 12, enabling the device to function as a wheelchair after releasing the support legs and deploying into a seat.

### FIG. 3: Operation Instructions for Lowering Support Legs

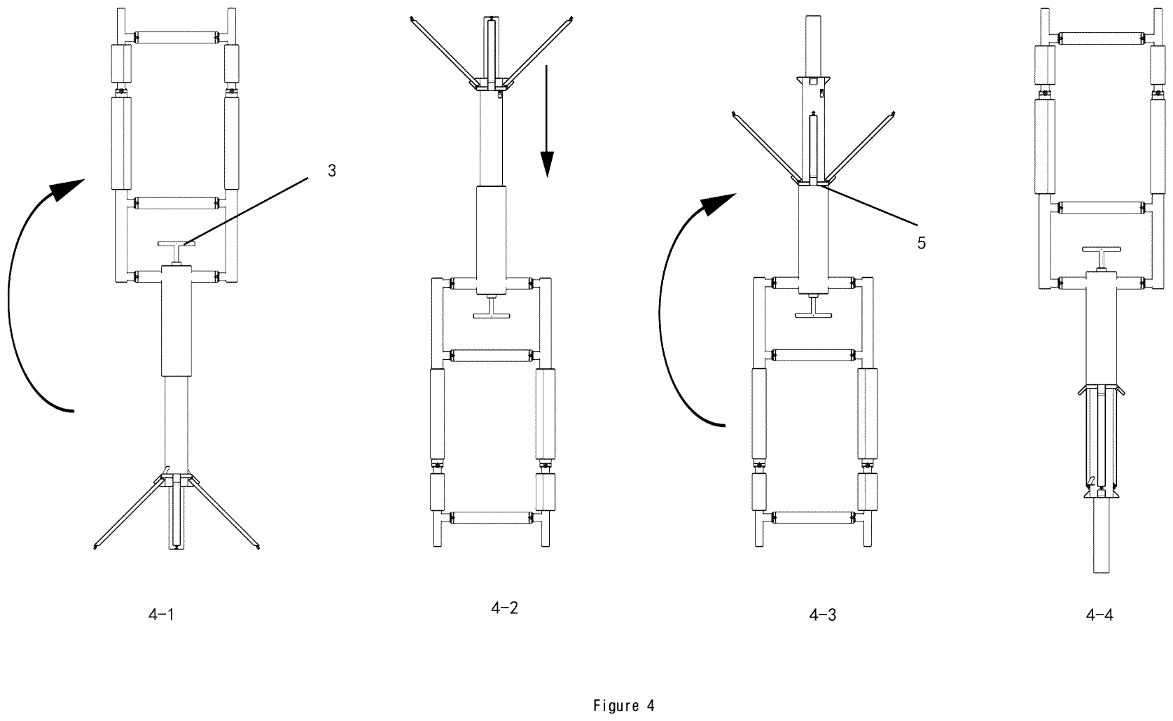

FIG. 3-1: Strike the crutch forcefully against the ground; due to inertia, the magnetic fixing ring 5 disengages and slides down freely;
FIG. 3-2: After sliding down, the support legs contact fixing device 11 and expand naturally;
FIG. 3-3: When the support legs contact fixing device 10, they push fixing device 10 into the rod due to gravity and continue sliding down;
FIG. 3-4: After the support legs are fully lowered, fixing device 10 extends outward under spring action, locking fixing ring 5. The support legs are jointly fixed by fixing device 11 and fixing device 9.

### FIG. 4: Operation Instructions for Retracting Support Legs

FIG. 4-1: Lift the crutch and pull handle 3 to retract fixing device 9;
FIG. 4-2: After lifting, the crutch is in an inverted state; due to gravity, the support legs will slide down freely;
FIG. 4-3: After sliding down to the initial position, the fixing ring 5 is adsorbed onto the rod by magnetic force;
FIG. 4-4: Turn the crutch back to restore the single-leg ground support state. When retracting the support legs (inverted state), first pull the internal device handle 3, driving rope 6 to move upward. Rope 6 turns direction via fixed pulley 7, pulling fixing device 9 to retract backward against the pressure of spring 8. Fixing ring 5, no longer restrained by fixing device 9, slides downward under gravity, approaches the ferromagnetic material on the crutch main body, and is automatically adsorbed and adhered to complete the leg retraction action.

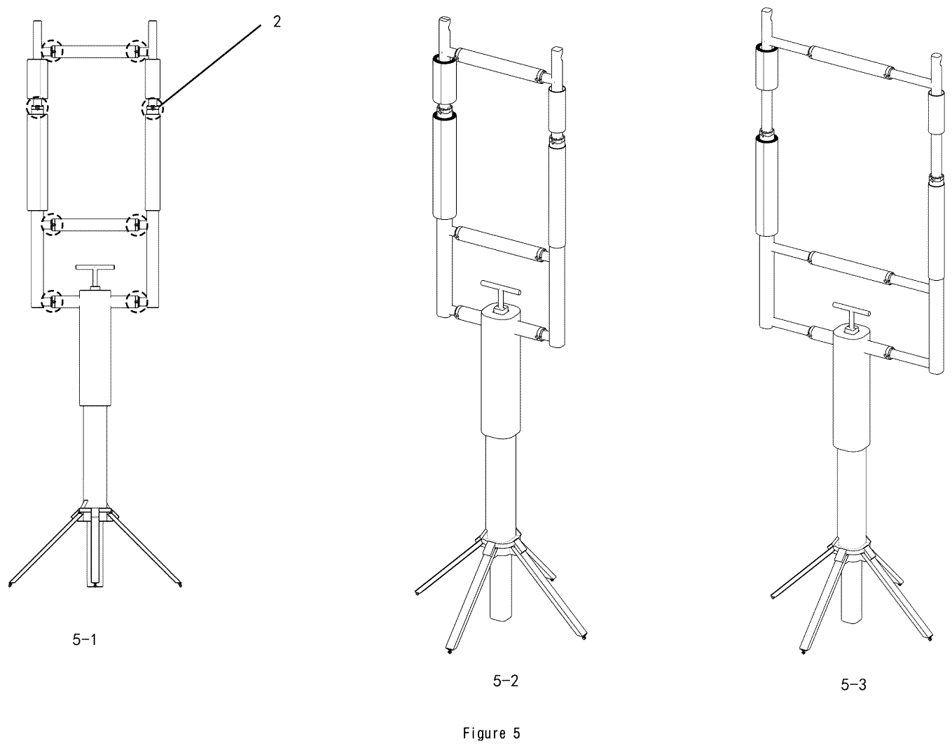

### FIG. 5: Crutch Length and Width Extension

FIG. 5-1: The length and width of the crutch can be freely adjusted via the elastic buckle
FIG. 5-2: Loosen the elastic buckle, extend the crutch length, then tighten to achieve length extension; FIG. 5-3: Loosen the elastic buckle, widen the crutch, then tighten to achieve width extension;

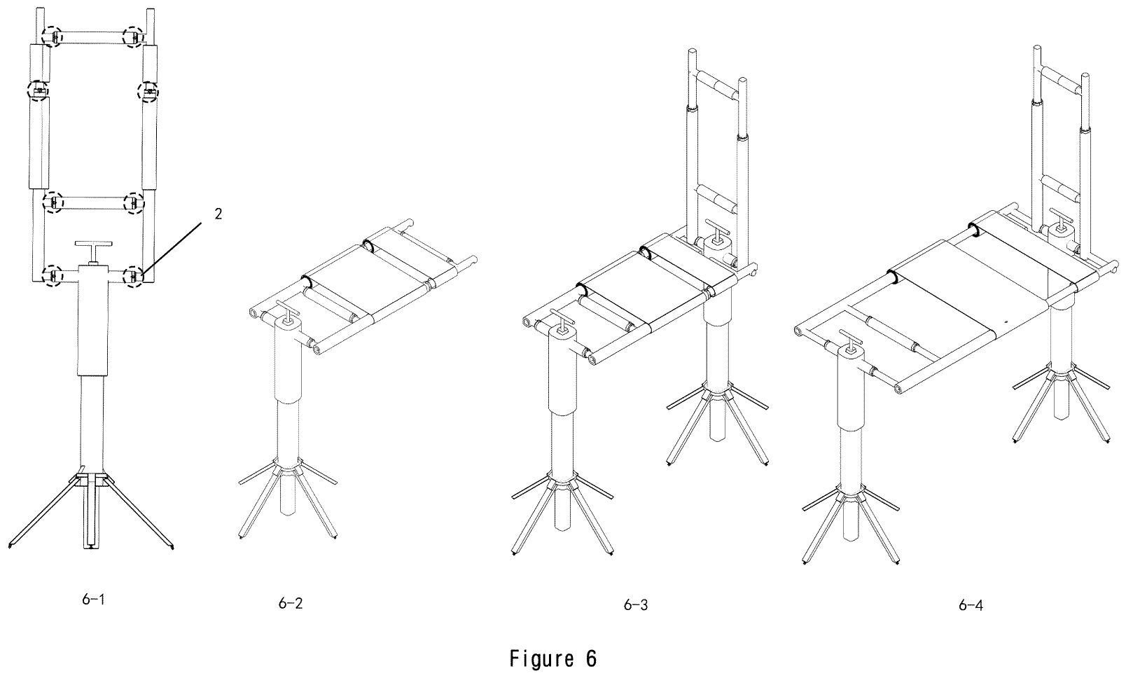

### FIG. 6: Seat Deployment Schematic

FIG. 6-1: Unscrew the elastic buckle 2 to rotate the upper part of the crutch;
FIG. 6-2: After rotating the upper part to the horizontal position, tighten the elastic buckle 2;
FIG. 6-3: Buckle the horizontal part onto the other crutch; FIG. 6-4: After fastening, unfold canvas 1 to form a seat.

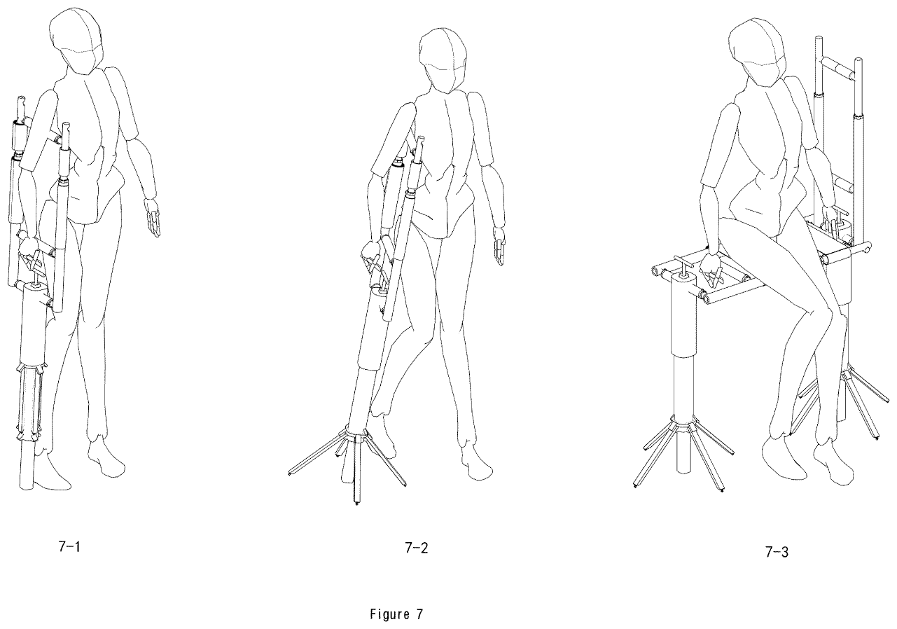

### FIG. 7: Three Usage States of the Device

FIG. 7-1: User walking with crutches
FIG. 7-2: User standing supported by the support legs
FIG. 7-3: User sitting and resting on the seat deployed by the device.

The above description of the disclosed embodiments enables those skilled in the art to make or use the present invention. Various modifications to these embodiments will be readily apparent to those skilled in the art. The general principles defined herein may be applied to other embodiments without departing from the spirit or scope of the utility model. Therefore, the present invention is not intended to be limited to the embodiments shown herein but is to be accorded the widest scope consistent with the principles and novel features disclosed herein.

1. Structural features of a multifunctional axillary crutch device, characterized in that:
i. Its appearance resembles a conventional axillary crutch and possesses all functionalities
of a conventional axillary crutch;
ii. Four expandable support legs are arranged on the main body of the device; after the
support legs are released and locked, the crutch stands
independently;
iii. Pulleys are installed below each of said support legs;
iv. iv. All structural components of the device are of a
telescopic design;
v. The support legs slide downward to the bottom of the device under gravity and automatically expand via a guiding and fixing device at the bottom;
vi. The support legs are limited to expanding within a specific angle by a limiting fixing device
and become locked to bear pressure and achieve self-standing;
vii. A magnet is built into the fixing ring, and the main body of the device is provided with ferromagnetic material; when the support legs are retracted, they are fixed via magnetic adsorption; viii. The part above the armrest of one axillary crutch is composed of telescopic tubular
structural members.

2. Usage methods of a multifunctional axillary crutch device, characterized in that:
i. When the user forcibly presses down the crutch, the support legs disengage from the magnetic adsorption constraint under inertial force, slide down to the bottom under gravity, automatically expand, and provide support to prevent falls;
ii. In strong support mode, the support legs always remain perpendicular to the ground within a preset angle range; regardless of how the angle of the crutch main body changes, when it lands on the ground, grip is provided by the four support legs.

3. Functional applications of a multifunctional axillary crutch device, characterized in that:
i. When two axillary crutches stand opposite each other, a seat is formed by rotating the armrest, causing the upper part of one crutch to fold down to a horizontal position and buckle onto the other; after unfolding the canvas, a seat is formed;
ii. A mobile bed is formed by extending the length and width via the telescopic structural
members;
iii. Wheelchair functionality is achieved via the pulleys;
iv. It is used as a conventional axillary crutch in normal mode; in strong support mode, the
angle range of the support legs is adjusted to adapt to different needs and prevent falls.
